(19) United States
(12) Patent Application Publication
(10) Pub. No.: US 2022/0043233 A1
(43) Pub. Date: Feb. 10, 2022

(54) FIXING RING FOR LENS MODULE, LENS MODULE, AND ELECTRONIC DEVICE

(71) Applicant: HON HAI PRECISION INDUSTRY CO., LTD., New Taipei (TW)

(72) Inventors: JEN-HUNG HUANG, New Taipei (TW); CHUN-CHENG KO, New Taipei (TW)

(21) Appl. No.: 17/108,151

(22) Filed: Dec. 1, 2020

(30) Foreign Application Priority Data
Aug. 5, 2020 (CN) 202010779324.5

(51) Int. Cl. G02B 7/02; G02B 5/00; G02B 9/34; G03B 30/00

(52) U.S. Cl. CPC G02B 7/026; G02B 5/003; G03B 30/00; G02B 9/34; G02B 7/021

(57) ABSTRACT

A fixing ring for a lens module includes a first end surface, a second end surface opposite the first end surface, and a through hole defined through the first end surface and the second end surface. A protrusion is provided on an inner wall of the through hole. The protrusion includes a first inclined surface, a second inclined surface, and a connecting surface. The connecting surface is coupled between the first inclined surface and the second inclined surface. A side of the first inclined surface away from the connecting surface is coupled to the first end surface. A side of the second inclined surface away from the connecting surface is coupled to the second end surface. A light absorbing layer is provided on the connecting surface.

### FIELD

The subject matter herein generally relates to lens modules, and more particularly to a fixing ring for a lens module.

### BACKGROUND

Generally, a fixing ring is used for fixing a lens module in a lens barrel. The fixing ring not only stabilizes the lens module, but also blocks out most stray light. However, due to insufficient machining accuracy or a material of the fixing ring, a tip portion of the fixing ring is not sharp enough, which causes a portion of light to be scattered, which negatively affects an imaging quality.

### BRIEF DESCRIPTION OF THE DRAWINGS

Implementations of the present disclosure will now be described, by way of embodiments, with reference to the attached figures.

FIG. 1 is a schematic perspective diagram of an embodiment of a lens module.

FIG. 2 is a cross-sectional diagram of the lens module taken along line II-II in FIG. 1.

FIG. 3 is a schematic perspective diagram of a fixing ring of the lens module.

FIG. 4 is a partial schematic diagram of the fixing ring shown in FIG. 3.

FIG. 5 is a partial cross-sectional diagram of the fixing ring shown in FIG. 3.

FIG. 6 is a cross-sectional diagram of the fixing ring showing a light path of an imaging light.

FIG. 7 is a cross-sectional diagram of a fixing ring in the related art showing a light path of an imaging light.

FIG. 8 is a schematic perspective diagram of an electronic device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or another word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

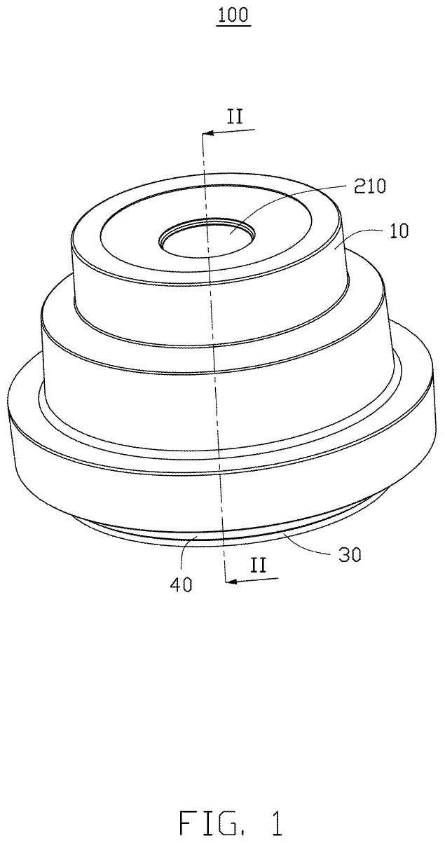

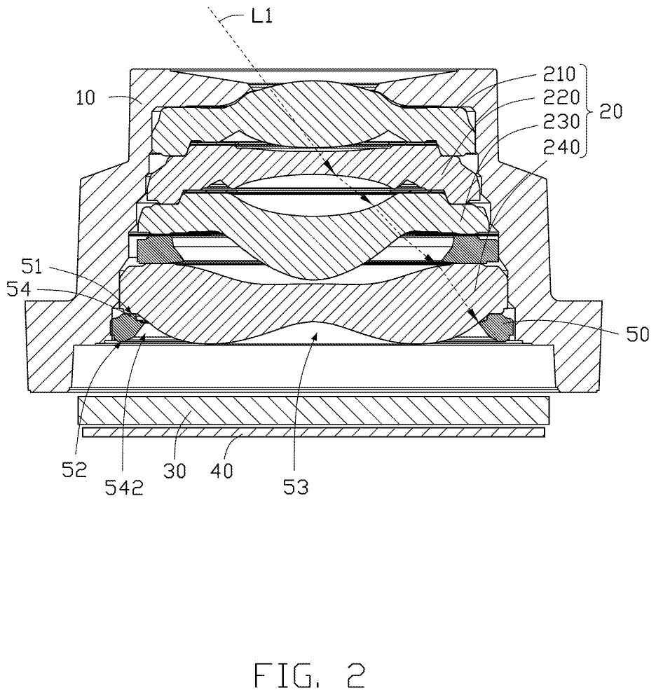

FIGS. 1 and 2 show an embodiment of a lens module 100. The lens module 100 includes a lens barrel 10, a lens group 20, a filter 30, an image sensor 40, and a fixing ring 50. The lens group 20, the fixing ring 50, the filter 30, and the image sensor 40 are arranged in sequence from an object side of the lens module 100 to an image side of the lens module 100. The lens group 20 includes a plurality of lenses and is received and fixed inside the lens barrel 10.

The fixing ring 50 is fixed between a lens of the lens group 20 most adjacent to the filter 30 and the filter 30 to fix the lens group 20 in the lens barrel 10. An outer diameter of the fixing ring 50 matches a size of an inner wall of the lens barrel 10 to satisfy an air gap size requirement of an optical design.

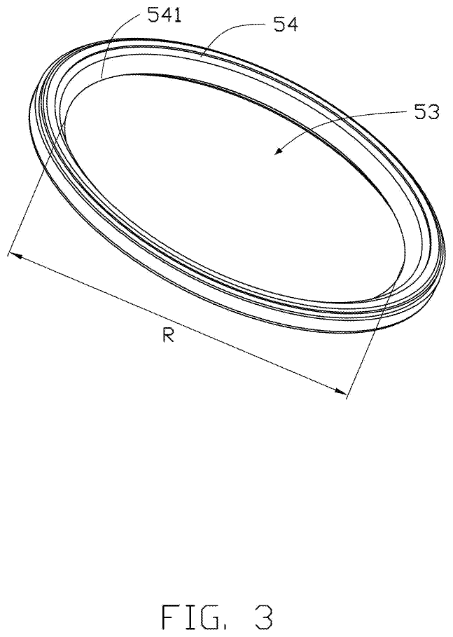

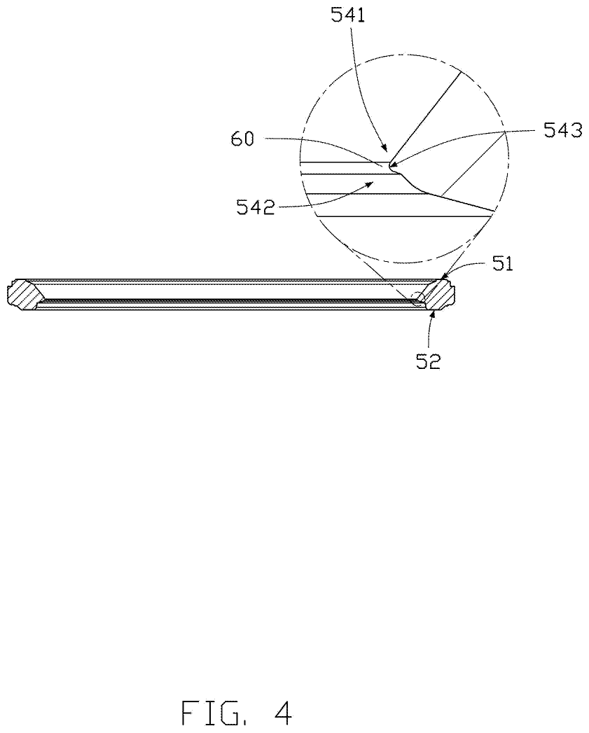

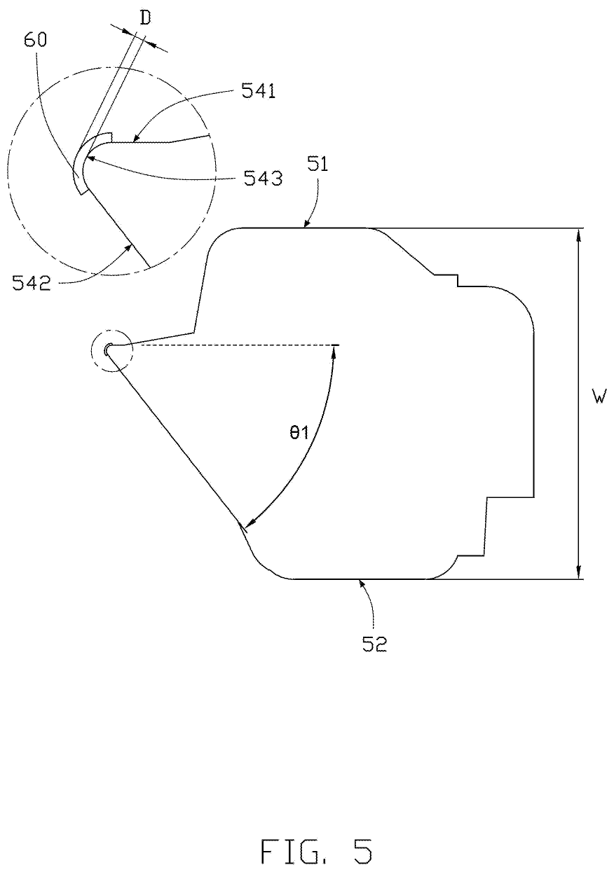

Referring to FIGS. 3, 4, and 5, the fixing ring 50 includes a first end surface 51 and a second end surface 52 that are parallel and opposite each other. A substantially central portion of the fixing ring 50 is provided with a through hole 53 for light transmission. The fixing ring 50 further includes a protrusion 54 provided on an inner wall of the through hole 53. The protrusion 54 includes a first inclined surface 541, a second inclined surface 542, and a connecting surface 543. The connecting surface 543 is coupled between the first inclined surface 541 and the second inclined surface 542. A side of the first inclined surface 541 away from the connecting surface 543 is coupled to the first end surface 51. A side of the second inclined surface 542 away from the connecting surface 543 is coupled to the second end surface 52. A light-absorbing layer 60 is provided on the connecting surface 543. The light-absorbing layer 60 is used to absorb an imaging light L1 incident thereon.

In one embodiment, the first end surface 51 faces the lens group 20, and the second end surface 52 faces the filter 30. In another embodiments, the first end surface 51 faces the filter 30, and the second end surface 52 faces the lens group 20.

In one embodiment, the connecting surface 543 is a curved surface protruding outward. Due to a limited accuracy of processing the protrusion 54, the connecting surface 543 is formed between the first inclined surface 541 and the second inclined surface 542.

In one embodiment, the first inclined surface 541 may be directly coupled to the first end surface 51, and the second inclined surface 542 may be directly coupled to the second end surface 52. In another embodiment, the first inclined surface 541 and the second inclined surface 542 may be respectively coupled to the first end surface 51 and the second end surface 52 through other surfaces.

In one embodiment, a material of the light absorbing layer 60 includes at least one of black polyethylene terephthalate or black liquid crystal polymer, and a thickness D of the light absorbing layer 60 is 1 μm-50 μm.

In one embodiment, a distance W between the first end surface 51 and the second end surface 52 is 0.25 mm-0.35 μm, and an included angle θ1 between the first inclined surface 541 and the second inclined surface 542 is 70°-180°. The distance W and the included angle θ1 satisfy the following relationship: 0.235≤W×sin(θ1)≤0.35.

By setting the distance W and the included angle θ1 to satisfy the above relationship, the first inclined surface 541 and the second inclined surface 542 can reflect the most stray light and improve an imaging quality. In one embodiment, the distance W is 0.33 mm, and the included angle θ1 is 75°.

In one embodiment, a diameter R of the through hole 53 decreases from the object side to the image side along the first inclined surface 541, and the diameter R of the through hole 53 increases from the object side to the image side along the second inclined surface 542. In one embodiment, the diameter R of the through hole 53 is 4.2 mm.

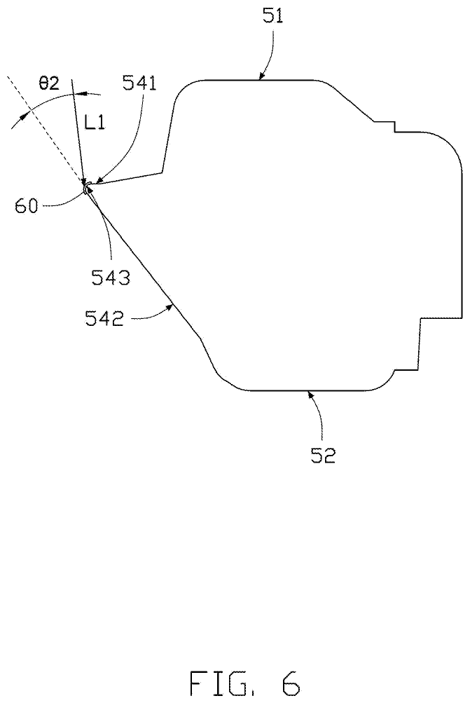

Referring to FIG. 6, during operation of the lens module 100, the imaging light L1 passes through the lens group 20 and is reflected from one side of the fixing ring 50 at an incident angle θ2)(55°≥θ2≥45° to the light-absorbing layer 60 on the connecting surface 543 of the protrusion 54. The light-absorbing layer absorbs the reflected imaging light L1 to prevent the imaging light L1 from being scattered by a tip portion of the protrusion 54, thereby improving an imaging quality.

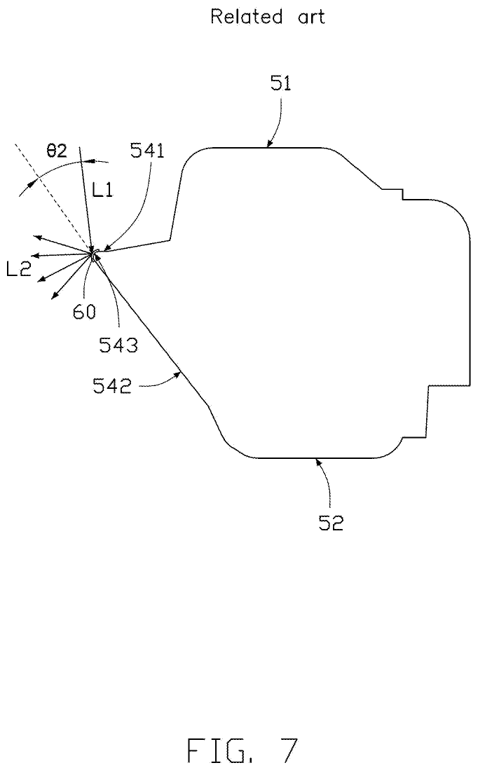

For comparison in the related art, referring to FIG. 7, when the light absorption layer 60 is not provided on the connecting surface 543 of the protrusion 54, the imaging light L1 is scattered on the connecting surface 543 to form stray light L2 in multiple directions, and the stray light L2 in the multiple directions causes degradation of an imaging quality.

Referring again to FIG. 2, in one embodiment, the lens group 20 includes a first lens 210, a second lens 220, a third lens 230, and a fourth lens 240 that are sequentially arranged in a direction from the object side of the lens module 100 to the image side of the lens module 100.

The first lens 210 may have a positive refractive effect. The first lens 210 includes a first surface protruded toward the object side and a second surface protruded toward the image side. The first surface and the second surface may both be spherical surfaces.

The second lens 220 may have a negative refractive effect. The second lens 220 includes a third surface recessed toward the image side and a fourth surface recessed toward the object side. The third surface and the fourth surface may both be spherical surfaces.

The third lens 230 may have a positive refractive effect. The third lens 230 includes a fifth surface recessed toward the image side and a sixth surface protruding toward the image side. The fifth surface and the sixth surface may both be spherical surfaces.

The fourth lens 240 may have a negative refractive effect. The fourth lens 240 includes a seventh surface and an eighth surface. Both the seventh surface and the eighth surface may be aspherical surfaces.

In one embodiment, the first end surface 51 is adjacent to the object side of the lens module 100, and the second end surface 52 is adjacent to the image side of the lens module 100.

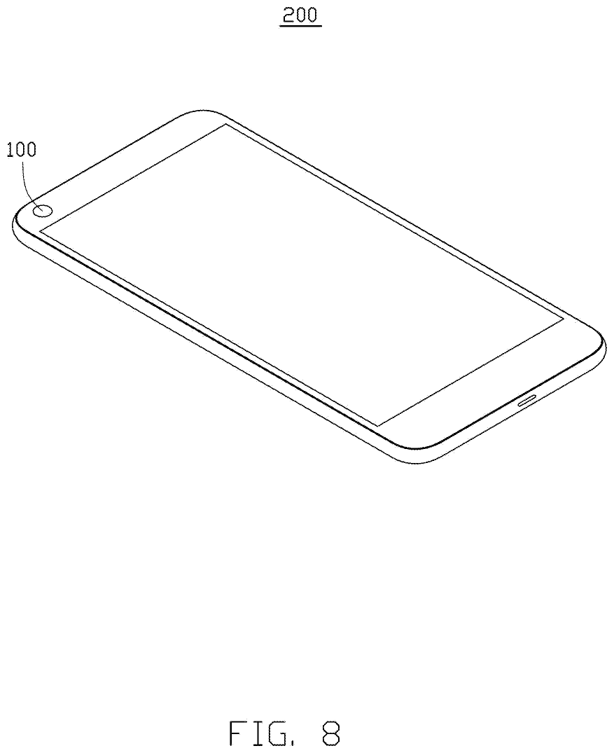

FIG. 8 shows an embodiment of an electronic device 200. The electronic device 200 includes the above-mentioned lens module 100. The electronic device 200 may be a mobile phone, a notebook computer, a desktop computer, a game console, a smart watch, or another device having a camera function.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A fixing ring for a lens module, the fixing ring comprising:
a first end surface;
a second end surface opposite the first end surface;
a through hole defined through the first end surface and the second end surface; and
a protrusion provided on an inner wall of the through hole; wherein:
the protrusion comprises a first inclined surface, a second inclined surface, and a connecting surface;
the connecting surface is coupled between the first inclined surface and the second inclined surface;
a side of the first inclined surface away from the connecting surface is coupled to the first end surface;
a side of the second inclined surface away from the connecting surface is coupled to the second end surface; and
a light absorbing layer is provided on the connecting surface.

2. The fixing ring of claim 1, wherein:
the connecting surface is a curved surface protruding outward from the inner wall of the through hole.

3. The fixing ring of claim 1, wherein:
a material of the light-absorbing layer comprises at least one of black polyethylene terephthalate and black liquid crystal polymer; and
a thickness of the light-absorbing layer is 1 μm-50 μm.

4. The fixing ring of claim 1, wherein:
a distance W between the first end surface and the second end surface is 0.25 mm-0.35 μm;
an included angle θ1 between the first inclined surface and the second inclined surface is 70°-180°; and
the distance W and the included angle θ1 satisfy the following relationship: 0.235≤W×sin(θ1)≤0.35.

5. The fixing ring of claim 1, wherein:
a diameter of the through hole decreases from an object side to an image side along the first inclined surface;
the diameter of the through hole increases from the object side to the image side along the second inclined surface; and
the diameter of the through hole includes 4.2 mm.

6. A lens module comprising:
a lens barrel;
a lens group;
a filter;
an image sensor; and
a fixing ring comprising:
a first end surface;
a second end surface opposite the first end surface;
a through hole defined through the first end surface and the second end surface; and
a protrusion provided on an inner wall of the through hole; wherein:
the protrusion comprises a first inclined surface, a second inclined surface, and a connecting surface;
the connecting surface is coupled between the first inclined surface and the second inclined surface;
a side of the first inclined surface away from the connecting surface is coupled to the first end surface;
a side of the second inclined surface away from the connecting surface is coupled to the second end surface;
a light absorbing layer is provided on the connecting surface;
the lens group, the fixing ring, the filter, and the image sensor are arranged in sequence from an object side to an image side of the lens module; and
the lens group is accommodated and fixed in the lens barrel.

7. The lens module of claim 6, wherein:
the first end surface faces the lens group, and the second end surface faces the filter.

8. The lens module of claim 7, wherein:
the lens group comprises a first lens, a second lens, a third lens, and a fourth lens that are sequentially arranged from the object side to the image side.

9. The lens module of claim 8, wherein:
the first lens has a positive refractive effect;
the second lens has a negative refractive effect;
the third lens has a positive refractive effect; and
the fourth lens has a negative refractive effect.

10. The lens module of claim 9, wherein:
the connecting surface is a curved surface protruding outward from the inner wall of the through hole.

11. The lens module of claim 10, wherein:
a material of the light-absorbing layer comprises at least one of black polyethylene terephthalate and black liquid crystal polymer; and
a thickness of the light-absorbing layer is 1 μm-50 μm.

12. The lens module of claim 11, wherein:
a distance W between the first end surface and the second end surface is 0.25 mm-0.35 μm;
an included angle θ1 between the first inclined surface and the second inclined surface is 70°-180°; and
the distance W and the included angle θ1 satisfy the following relationship: 0.235≤W×sin(θ1)≤0.35.

13. The lens module of claim 12, wherein:
a diameter of the through hole decreases from an object side to an image side along the first inclined surface;
the diameter of the through hole increases from the object side to the image side along the second inclined surface; and
the diameter of the through hole includes 4.2 mm.

14. An electronic device comprising a lens module comprising:
a lens barrel;
a lens group;
a filter;
an image sensor; and
a fixing ring comprising:
a first end surface;
a second end surface opposite the first end surface;
a through hole defined through the first end surface and the second end surface; and
a protrusion provided on an inner wall of the through hole; wherein:
the protrusion comprises a first inclined surface, a second inclined surface, and a connecting surface;
the connecting surface is coupled between the first inclined surface and the second inclined surface;
a side of the first inclined surface away from the connecting surface is coupled to the first end surface;
a side of the second inclined surface away from the connecting surface is coupled to the second end surface;
a light absorbing layer is provided on the connecting surface;
the lens group, the fixing ring, the filter, and the image sensor are arranged in sequence from an object side to an image side of the lens module; and
the lens group is accommodated and fixed in the lens barrel.

15. The electronic device of claim 14, wherein:
the first end surface faces the lens group, and the second end surface faces the filter.

16. The electronic device of claim 15, wherein:
the lens group comprises a first lens, a second lens, a third lens, and a fourth lens that are sequentially arranged from the object side to the image side;
the first lens has a positive refractive effect;
the second lens has a negative refractive effect;
the third lens has a positive refractive effect; and
the fourth lens has a negative refractive effect.

17. The electronic device of claim 16, wherein:
the connecting surface is a curved surface protruding outward from the inner wall of the through hole.

18. The electronic device of claim 17, wherein:
a material of the light-absorbing layer comprises at least one of black polyethylene terephthalate and black liquid crystal polymer; and
a thickness of the light-absorbing layer is 1 μm-50 μm.

19. The electronic device of claim 18, wherein:
a distance W between the first end surface and the second end surface is 0.25 mm-0.35 μm;
an included angle θ1 between the first inclined surface and the second inclined surface is 70°-180°; and
the distance W and the included angle θ1 satisfy the following relationship: 0.235≤W×sin(θ1)≤0.35.

20. The lens module of claim 19, wherein:
a diameter of the through hole decreases from an object side to an image side along the first inclined surface;
the diameter of the through hole increases from the object side to the image side along the second inclined surface; and
the diameter of the through hole includes 4.2 mm.
